(19) United States
(12) Patent Application Publication
(10) Pub. No.: US 2026/0342058 A1
(43) Pub. Date: Oct. 29, 2026

(54) PROTECTOR, AND WIRE ASSEMBLY

(71) Applicant: SUMITOMO WIRING SYSTEMS, LTD., Mie (JP)

(72) Inventors: Naoya EHARA, Mie (JP); Kokai YAMADA, Mie (JP)

(21) Appl. No.: 19/655,078

(22) Filed: Apr. 22, 2026

(30) Foreign Application Priority Data
Apr. 24, 2025 (JP) 2025-072196

(51) Int. Cl. H02G 3/04

(52) U.S. Cl. CPC H02G 3/04

(57) ABSTRACT

The protector includes: an accommodating portion that accommodates a wire member in which a plurality of wires are bundled in a flat shape by a base member, in a state where the wire member is drawn out from both sides of the accommodating portion; and a cover that covers the accommodating portion to suppress rising of the wire member accommodated in the accommodating portion. The protector includes a lock mechanism that locks the cover to the accommodating portion by engagement of first engagement portions formed in the accommodating portion with second engagement portions formed in the cover. The lock mechanism also locks the position of the base member relative to the accommodating portion.

### CROSS-REFERENCE TO RELATED APPLICATIONS

This application is based on and claims priority from Japanese Patent Application No. 2025-072196, filed on April 24, 2025, with the Japan Patent Office, the disclosure of which is incorporated herein in its entirety by reference.

### TECHNICAL FIELD

The present disclosure relates to a protector and a wire assembly.

### BACKGROUND

A module including a wire harness, in which a plurality of wires are bundled with a tie band, and a protector accommodating the wire harness, such as that disclosed in JP 2006-246663 A, is well-known. The protector has a lid that covers an opening in a body of the protector. The lid is maintained in the closed state by a lock portion formed in the lid being locked to a locking portion of the body of the protector. The wire harness is locked to the protector by a retaining portion formed in the tie band being retained in a retaining hole formed in the body of the protector.

In the case of JP 2006-246663 A, separate structures for locking the lid of the protector and for locking the position of the wire harness are required. This complicates the structure of the module including the wire harness and the protector. It has therefore been necessary to simplify the configuration of the module in order to meet various demands, such as for smaller size, lighter weight, and lower cost.

### SUMMARY

An object of the present disclosure is to provide a protector, as well as a wire assembly, that enable simplifying the configuration of an assembly including a wire member.

A protector that solves the issues described above includes: an accommodating portion configured to accommodate a wire member, in which a plurality of wires are bundled in a flat shape by a base member, in a state where the wire member is drawn out from both sides of the accommodating portion; and a cover configured to cover the accommodating portion to suppress rising of the wire member accommodated in the accommodating portion, the protector further including: a lock mechanism configured to lock the cover to the accommodating portion by engagement of a first engagement portion formed in the accommodating portion with a second engagement portion formed in the cover, wherein the lock mechanism also locks a position of the base member relative to the accommodating portion.

The present disclosure enables simplifying the configuration of an assembly including a wire member.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view of a wire assembly according to one embodiment.

FIG. 2 is a perspective view of a wire member.

FIG. 3 is a cross-sectional view as seen from a line III-III shown in FIG. 2.

FIG. 4 is a perspective view of a protector with a cover open.

FIG. 5 is a perspective view of the protector with the cover closed, as seen from the rear.

FIG. 6 is a cross-sectional view as seen from a line VI-VI shown in FIG. 1.

FIG. 7 is a cross-sectional view as seen from a line VII-VII shown in FIG. 1.

FIG. 8 is a state diagram illustrating the wire member set in the protector with the cover open.

FIGS. 9A and 9B are sequence diagrams illustrating a base member engaging with a projection of a lock mechanism.

FIGS. 10A to 10C are sequence diagrams illustrating the transitioning of the lock mechanism to a locked state.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

First, embodiments of the present disclosure will be described as examples.

[1] A protector of the present disclosure includes: an accommodating portion configured to accommodate a wire member, in which a plurality of wires are bundled in a flat shape by a base member, in a state where the wire member is drawn out from both sides of the accommodating portion; and a cover configured to cover the accommodating portion to suppress rising of the wire member accommodated in the accommodating portion, the protector further including: a lock mechanism configured to lock the cover to the accommodating portion by engagement of a first engagement portion formed in the accommodating portion with a second engagement portion formed in the cover, wherein the lock mechanism also locks a position of the base member relative to the accommodating portion.

According to this configuration, the locking of the cover of the protector and the locking of the position of the base member of the wire member accommodated in the protector are achieved by the single lock mechanism. It is therefore not necessary to separately provide lock mechanisms for locking the cover of the protector and for locking the position of the base member of the wire member. This makes it possible to simplify the configuration of the assembly including the wire member.

2 In the foregoing [1], the accommodating portion and the cover may be formed integrally. According to this configuration, component management is easier.

3 In the foregoing [1] or [2], one of the first engagement portion and the second engagement portion may be a projection capable of elastic deformation, another one of the first engagement portion and the second engagement portion may be a recess that engages with the projection to cause the lock mechanism to transition to a locked state, the base member may have a hole into which the projection is insertable, and by the projection inserted into the hole in the base member engaging with the recess, the lock mechanism may lock the cover to the accommodating portion and locks the position of the base member relative to the accommodating portion. According to this configuration, the locking of the closed state of the cover and the locking of the position of the base member can be achieved with a single lock mechanism using a simple configuration in which the projection inserted into the hole in the base member is engaged with the recess.

4 In the foregoing [3], the cover may include a first wall portion disposed facing a long side surface of the wire member having the flat shape, and a second wall portion disposed facing a short side surface of the wire member having the flat shape, the second engagement portion being disposed in the second wall portion, the hole may be provided in a base member end formed at an end of the base member in a direction in which the plurality of wires are arranged next to each other, and the lock mechanism may transition to the locked state such that the base member end having the hole with the projection inserted therein is interposed between the accommodating portion and the second wall portion. According to this configuration, when the position of the base member of the wire member is locked by the lock mechanism, the base member end is supported between the accommodating portion and the second wall portion. This makes it possible to suppress movement of the base member in the locked state. Accordingly, when the position of the base member is locked by the lock mechanism, the locked state can be maintained with ease.

5 In the foregoing [4], the accommodating portion may have a support portion supporting the first wall portion from a rear surface when the cover is in a closed state. According to this configuration, the first wall portion of the cover in the closed state is supported by the support portion of the accommodating portion, and the cover can therefore be stably kept in the closed state.

6 In the foregoing [4], the second wall portion may include a first hinge that connects the second wall portion to the first wall portion in a rotatable manner, and a second hinge that enables the second wall portion to bend, at an intermediate position between a tip of the second wall portion and the first hinge. According to this configuration, the second wall portion has a double-hinge structure, which increases the freedom of movement of the second wall portion. This makes it possible to improve the usability when closing the cover.

7 In any one of the foregoing [1] to [6], the accommodating portion 16 may include an extension portion formed in a bottom wall of the accommodating portion and extending in a direction away from the bottom wall, and a reinforcing portion that reinforces the extension portion, and the first engagement portion may be provided in the extension portion reinforced by the reinforcing portion. According to this configuration, the first engagement portion is provided in a portion having high strength, which improves the durability of the lock mechanism. This makes it unlikely for the lock mechanism to become unlocked unintentionally.

8 A wire assembly of the present disclosure includes a wire member in which a plurality of wires are bundled in a flat shape by a base member; and a protector configured to accommodate the wire member, wherein the protector includes an accommodating portion configured to accommodate the wire member in a state where the wire member is drawn out from both sides of the accommodating portion, a cover configured cover the accommodating portion to suppress rising of the wire member accommodated in the accommodating portion, and a lock mechanism configured lock the cover to the accommodating portion by engagement of a first engagement portion formed in the accommodating portion with a second engagement portion formed in the cover, and the lock mechanism also locks a position of the base member relative to the accommodating portion. According to this configuration, effects similar to those described above in [1] can be achieved.

A specific example of the present disclosure will be described hereinafter with reference to the drawings. Note that the present disclosure is not intended to be limited to this example, and is defined instead by the scope of the appended claims. All changes that fall within the same essential spirit and scope as the scope of the claims are intended to be included therein as well. In the drawings, some parts of the configuration may be exaggerated or simplified to simplify the descriptions. The dimensional proportions of parts may differ from the actual dimensional proportions as well.

### Wire Assembly 1

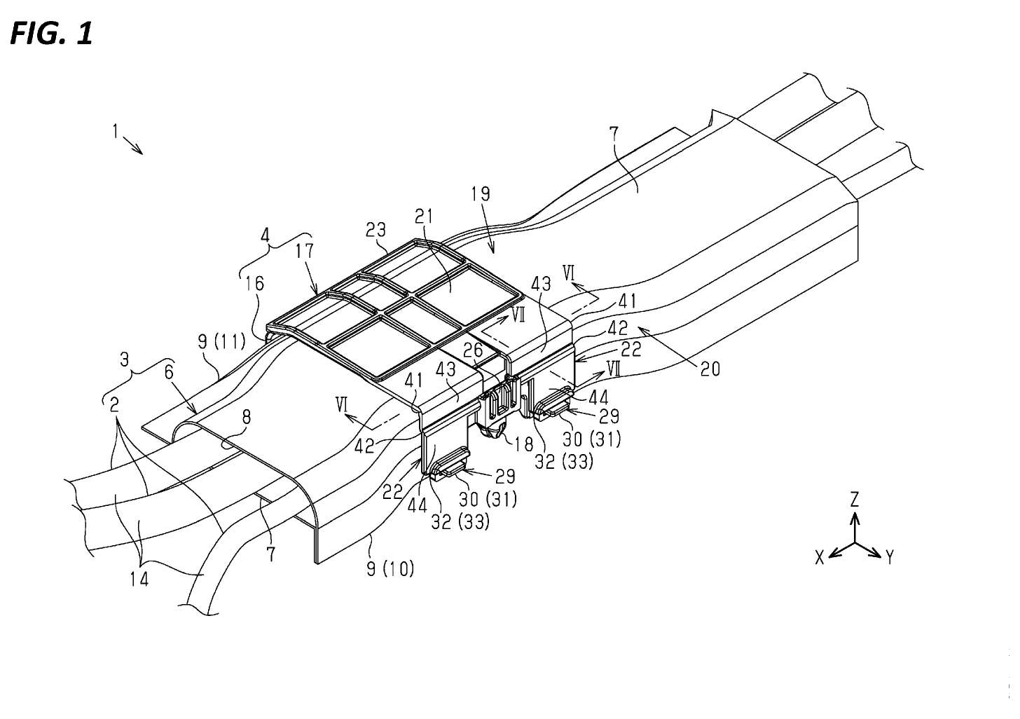

As illustrated in FIG. 1, a wire assembly 1 includes a wire member 3 having at least one (a plurality, in this example) wire 2, and a protector 4 accommodating the wire member 3 therein. The wire assembly 1 electrically connects two or more devices, for example. High-voltage batteries, inverters, motors, electrical connection boxes, and the like can be given as examples of the devices. Relay boxes, fuse boxes, junction boxes, and the like can be given as examples of the electrical connection boxes.

### Wire Member 3

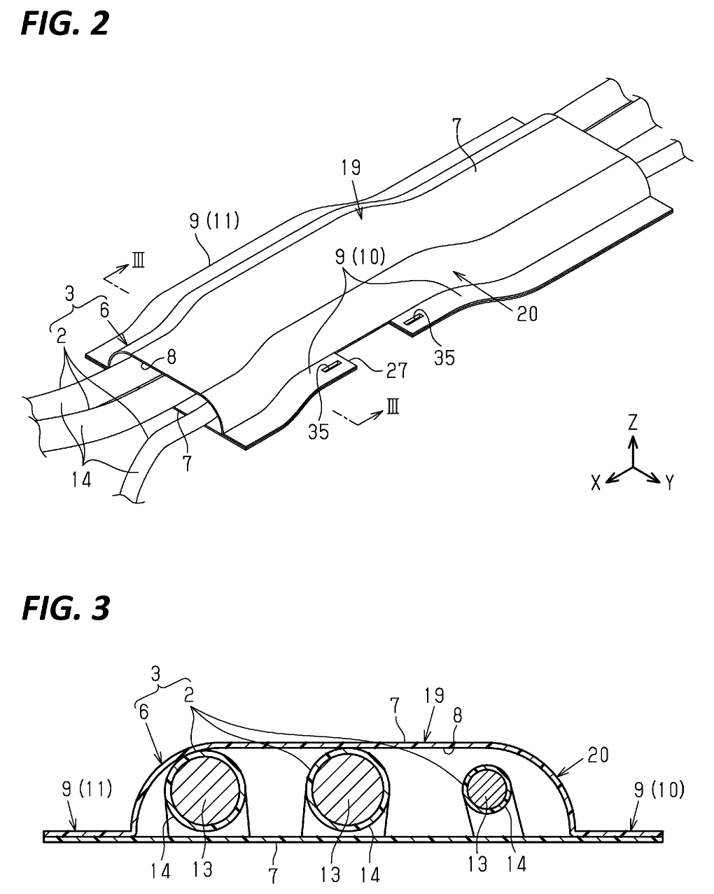

As illustrated in FIGS. 2 and 3, the wire member 3 has a base member 6 that bundles the plurality of wires 2 in a flat shape. The wire member 3 is therefore what is known as an "area harness", in which the plurality of wires 2 are arranged in a flat shape by the base member 6. The base member 6 is extends in the axial direction of the wires 2, and therefore has a lengthwise direction and a widthwise direction.

By bonding corresponding ends of two opposing sheets 7 to each other, for example, the base member 6 is formed in the shape of a bag having a space 8 therein. The sheets 7 accommodate the plurality of wires 2 in the interior space 8. The sheets 7 are formed of a resin material such as polyvinyl chloride (PVC), polyethylene terephthalate (PET), or polypropylene (PP), for example. However, the sheets 7 may be formed of a fiber material such as a nonwoven fabric, a woven fabric, a knitted fabric, or the like, or may be formed of a non-fiber material such as a foam body. The sheets 7 may contain a metal material. Methods using ultrasonic welding, thermal compression welding, hot air welding, high-frequency welding, and the like can be given as examples of methods for bonding the sheets 7. Methods using an adhesive, double-sided tape, sewing, and the like can also be given as examples of methods for bonding the sheets 7.

The base member 6 has base member ends 9, formed by bonding the two sheets 7, at both ends in the widthwise direction of the base member 6 (a Y-axis direction, in FIG. 2). The base member ends 9 include a first base member end 10 disposed at one end (the right side of the figure, in this example) in the widthwise direction of the base member 6 (the Y-axis direction, in FIG. 2), and a second base member end 11 disposed at the other end (the left side of the figure, in this example) in the widthwise direction of the base member 6 (the Y-axis direction, in FIG. 2). Note that the widthwise direction of the base member 6 is a direction parallel to the direction in which the plurality of wires 2 are arranged next to each other.

As illustrated in FIG. 3, each of the wires 2 includes a conductive core wire 13 and an insulative coating 14 that covers the core wire 13. The insulative coating 14 covers the outer circumferential surface of the core wire 13 over the entirety thereof in the circumferential direction. The insulative coating 14 is constituted by an insulative resin material, for example. An electrical terminal (not shown) that can be electrically connected to the connection target of the wire 2 is attached and secured to the tip of the core wire 13.

### Protector 4

As illustrated in FIGS. 1, 4, and 5, the protector 4 includes an accommodating portion 16 that accommodates the wire member 3 in a state where the wire member 3 is drawn out from both sides thereof, and a cover 17 that covers the accommodating portion 16 to suppress rising of the wire member 3 accommodated in the accommodating portion 16. The accommodating portion 16 and the cover 17 are formed integrally. In the accommodating portion 16, one end of the wire member 3 is drawn out from an opening located at one end in the wire axial direction (an X-axis direction, in FIGS. 1 and the like), and the other end of the wire member 3 is drawn out from an opening located at the other end in the wire axial direction (the X-axis direction, in FIGS. 1 and the like). As illustrated in FIG. 5, a clamp 18 for securing to a mounting target (not shown) is formed on the rear surface of the accommodating portion 16.

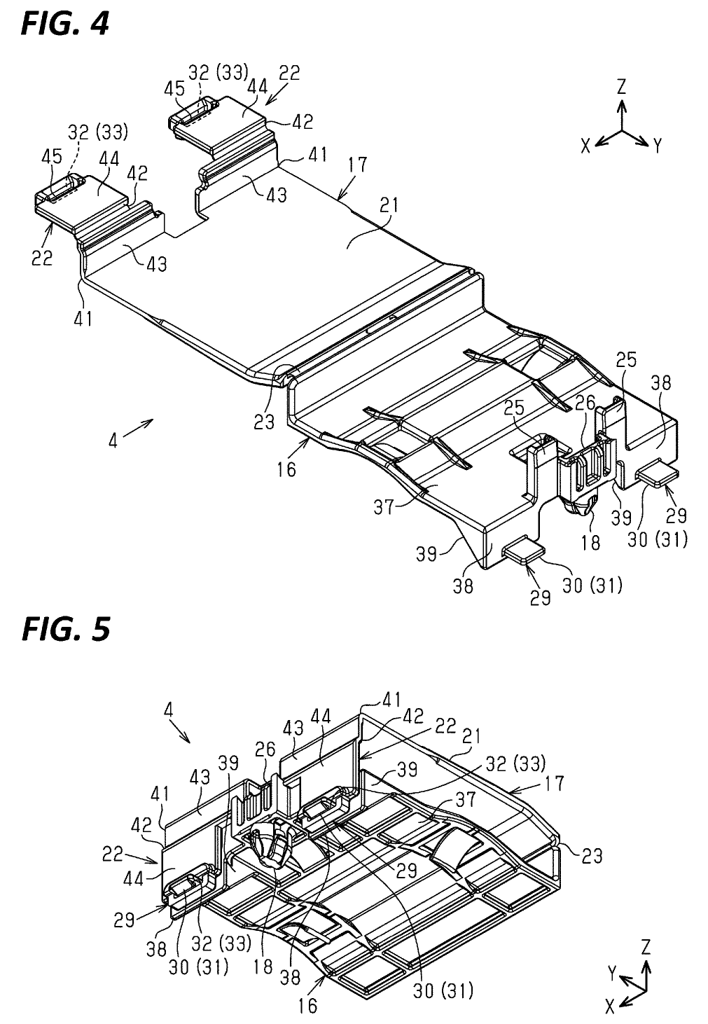

As illustrated in FIGS. 4 and 5, the cover 17 includes a first wall portion 21 disposed facing a long side surface of the flat-shaped wire member 3 (a first surface 19 indicated in FIGS. 1 to 3), and second wall portions 22 disposed facing a short side surface of the flat-shaped wire member 3 (a second surface 20 indicated in FIGS. 1 to 3). The first wall portion 21 is connected to the accommodating portion 16 so as to be capable of opening and closing by what is known as a cantilever structure, in which one of a plurality of sides thereof is connected by a connecting hinge 23. The second wall portions 22 are provided as a pair arranged next to each other in a direction intersecting with an opening/closing direction of the cover 17 (the X-axis direction, in FIGS. 4 and the like).

### Support of First Wall Portion 21

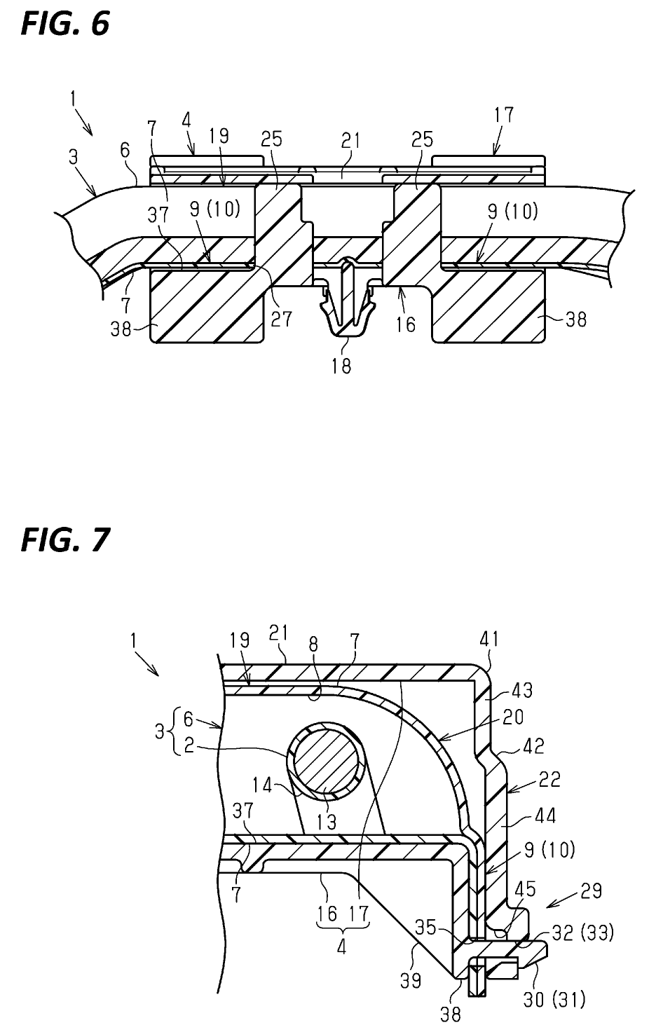

As illustrated in FIGS. 4 and 6, the accommodating portion 16 has support portions 25 supporting the first wall portion 21 from a rear surface thereof when the cover 17 is closed. The support portions 25 are provided as a pair arranged next to each other in a direction intersecting with an opening/closing direction of the cover 17 (the X-axis direction, in FIG. 4). A component attachment portion 26 for attaching other components (clips or the like, for example; not shown) is provided between the pair of support portions 25.

### Shape of First Base Member End 10 of Base Member 6

As illustrated in FIG. 2, a cutout 27 (see FIGS. 2 and the like) for avoiding interference with the support portions 25 when attaching the wire member 3 to the protector 4 is formed in the first base member end 10 of the base member 6. The cutout 27 is formed by removing a part of the first base member end 10 through cutting or the like, for example.

### Lock Mechanism 29

As illustrated in FIGS. 4, 5, and 7, the protector 4 includes a lock mechanism 29 that locks the cover 17 to the accommodating portion 16 by engaging first engagement portions 30 formed in the accommodating portion 16 with second engagement portions 32 formed in the cover 17. Either the first engagement portions 30 or the second engagement portions 32 (the first engagement portions 30, in this example) are projections 31 capable of elastic deformation. Each of the projections 31 is formed in a shape having a claw at a tip thereof, for example. The other ones out of the first engagement portions 30 and the second engagement portions 32 (the second engagement portions 32, in this example) are recesses 33 that transition the lock mechanism 29 to a locked state by engaging with the projections 31. The recesses 33 are through-holes, for example.

In this example, in the lock mechanism 29, the projections 31, which are the first engagement portions 30, are formed in the accommodating portion 16, and the recesses 33, which are the second engagement portions 32, are formed in the cover 17. The lock mechanism 29 has a plurality of sets of one projection 31 and one recess 33 (two sets, in this example). A set of one projection 31 and one recess 33 is disposed on both side parts of the protector 4 in the lengthwise direction thereof (the X-axis direction, in FIGS. 4 and the like). In this example, the lock mechanism 29 transitions to the locked state by insertion engagement of the projections 31 of the accommodating portion 16 with the recesses 33 of the cover 17.

### Locking of Base Member 6 by Lock Mechanism 29

As illustrated in FIGS. 2 and 7, the base member 6 has holes 35 into which the projections 31 are inserted. The holes 35 are formed in the first base member end 10 of the base member 6. The holes 35 are formed as slits into which the projections 31 can be inserted. Two holes 35 are formed in accordance with the number of sets of the projections 31 and the recesses 33. The lock mechanism 29 locks the cover 17 to the accommodating portion 16, and also locks the position of the base member 6 relative to the accommodating portion 16, by engaging the projections 31 inserted into the holes 35 in the base member 6 with the recesses 33. Accordingly, the lock mechanism 29 not only locks the cover 17, but also locks the position of the base member 6 relative to the accommodating portion 16.

### Arrangement and Structure of First Engagement Portions 30

As illustrated in FIGS. 4, 5, and 7, the accommodating portion 16 includes extension portions 38 formed in a bottom wall 37 of the accommodating portion 16 extending in a direction away from the bottom wall 37, and reinforcing portions 39 that reinforce the extension portions 38. The extension portions 38 are disposed at edges of the bottom wall 37 closed by the cover 17, on both sides of the protector 4 in the lengthwise direction thereof (the X-axis direction, in FIGS. 4 and the like). The reinforcing portions 39 are formed as pairs on both sides of each of the extension portions 38. The first engagement portions 30 are provided on corresponding ones of the extension portions 38 reinforced by the reinforcing portions 39.

### Shape of Second Wall Portions 22

As illustrated in FIGS. 4, 5, and 7, each of the second wall portions 22 includes a first hinge 41 that connects the second wall portion 22 to the first wall portion 21 in a rotatable manner, and a second hinge 42 that enables the second wall portion 22 to bend at an intermediate position between the tip of the second wall portion 22 and the first hinge 41. The second wall portions 22 therefore have a double-hinge structure in which hinges are present at two locations. In this example, each of the second wall portions 22 includes a proximal end piece 43 located between the first hinge 41 and the second hinge 42, and a distal end piece 44 located closer to the distal end than the second hinge 42 is. The second engagement portion 32 is provided in the distal end piece 44 of the second wall portion 22.

As illustrated in FIG. 7, the distal end piece 44 is formed in a shape that positions the piece further outward than the proximal end piece 43 by an amount equivalent to the thickness of the first base member end 10 interposed between the extension portion 38 of the accommodating portion 16 and the second wall portion 22 of the cover 17. A concave escape portion 45 is formed in an inner surface of the distal end piece 44, along a peripheral edge of the recess 33 serving as the second engagement portion 32. When the projections 31 inserted into the holes 35 in the first base member end 10 are locked to the recesses 33 and the first base member end 10 bends at the peripheral edges of the holes 35, that bending is accommodated by the escape portion 45.

### Actions of Embodiment

Actions of the protector 4 (the wire assembly 1) according to the present embodiment will be described next.

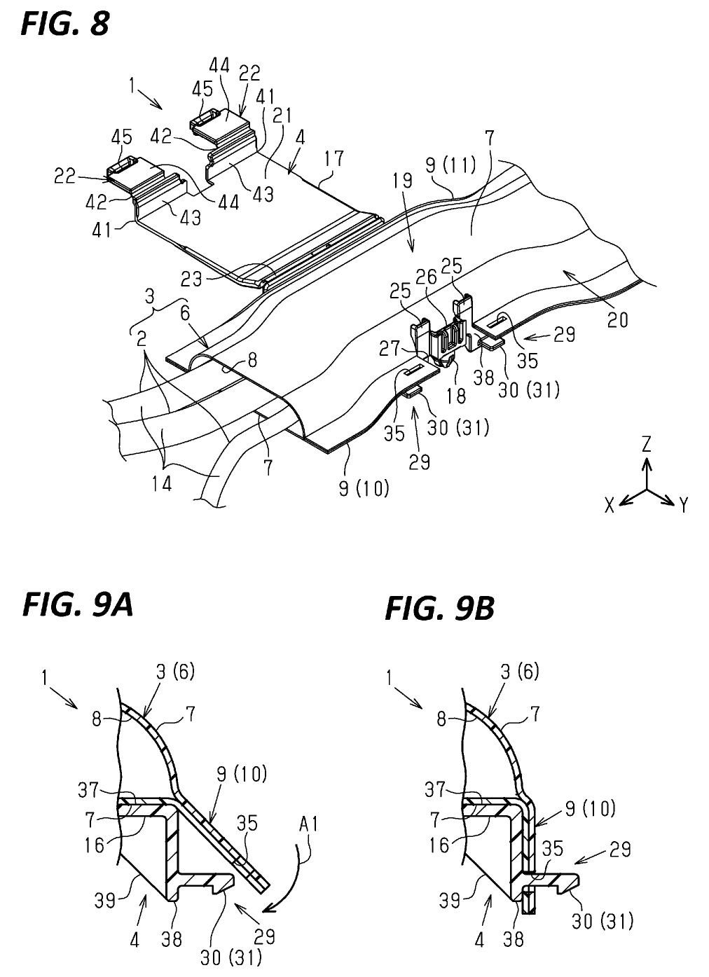

As illustrated in FIG. 8, the wire member 3 is set in the protector 4 with the cover 17 open. At this time, the wire member 3 is set in the protector 4 such that the support portions 25 formed in the accommodating portion 16 of the protector 4 pass through the interior of the cutout 27 formed in the first base member end 10 of the base member 6. In addition, the second base member end 11 of the base member 6 is accommodated with the parts thereof disposed in the accommodating portion 16 in a folded state.

After the wire member 3 is accommodated in the accommodating portion 16 of the protector 4, the first base member end 10 of the base member 6 of the wire member 3 is bent downward (in the direction of an arrow A1) to insert the projections 31 formed in the accommodating portion 16 into the holes 35 formed in the first base member end 10 of the base member 6 of the wire member 3, as illustrated in FIG. 9A. Then, as illustrated in FIG. 9B, the first base member end 10 is bent further to insert the projections 31 of the accommodating portion 16 into the holes 35 in the first base member end 10. Accordingly, the base member 6 is temporarily fixed to the accommodating portion 16 by the projections 31 engaging with the holes 35 in the first base member end 10.

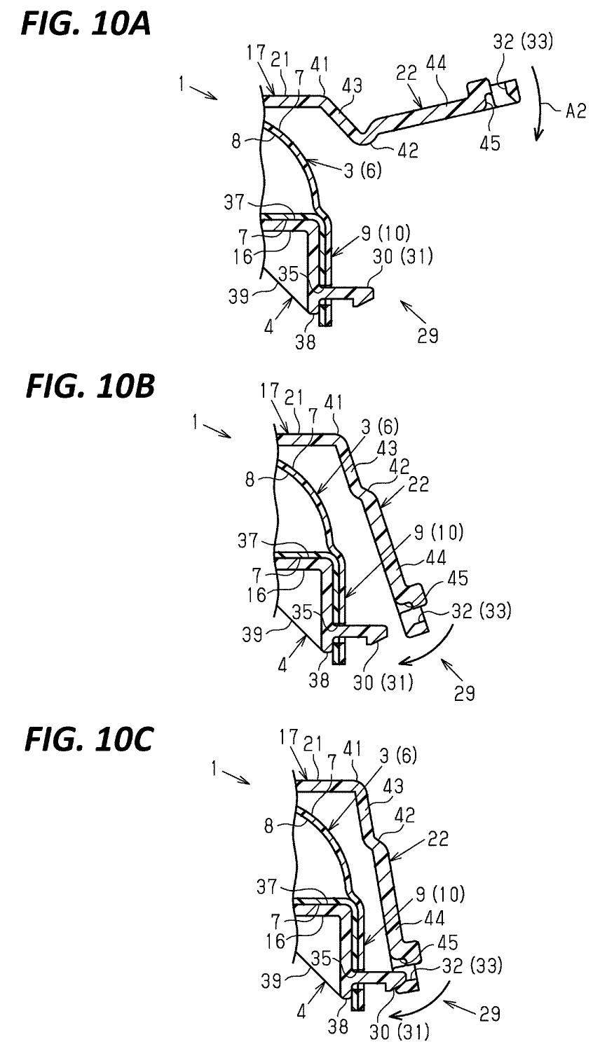

As illustrated in FIGS. 10A and 10B, after the base member 6 is temporarily fixed to the accommodating portion 16 of the protector 4, the cover 17 is closed. In this example, to engage the projections 31, with which the first base member end 10 is engaged, with the recesses 33 in the second wall portion 22, the second wall portion 22 is rotated in a closing direction (the direction of an arrow A2 in FIG. 10A) mainly with the first hinge 41 as the point of support. Note that at this time, rotation of the second wall portion 22 with the second hinge 42 as the point of support may be included.

Next, as illustrated in FIG. 10C, as the recess 33 reaches the projection 31, the claw at the tip of the projection 31 enters into the recess 33 while elastically deforming. Then, when the projection 31 is fully fitted with the recess 33, the elastic deformation of the projection 31 is released and the projection 31 engages with the recess 33, which causes the projection 31 and the recess 33 to transition to the locked state (the state in FIG. 7). At this time, the first base member end 10 of the base member 6 is interposed between the distal end piece 44 of the second wall portion 22 and the extension portion 38 of the accommodating portion 16. Through this, the closed state of the cover 17 and the position of the base member 6 are locked by the lock mechanism 29.

### Effects of Embodiment

The protector 4 (the wire assembly 1) according to the foregoing embodiment can achieve the following effects.

(1) The protector 4 includes the accommodating portion 16 that accommodates the wire member 3, and the cover 17 that covers the accommodating portion 16. The protector 4 locks the cover 17 to the accommodating portion 16, and also locks the position of the base member 6 of the wire member 3 relative to the accommodating portion 16.

According to this configuration, the locking of the cover 17 of the protector 4 and the locking of the position of the base member 6 of the wire member 3 accommodated in the protector 4 are achieved by the single lock mechanism 29. It is therefore not necessary to provide separate lock mechanisms 29 for locking the cover 17 of the protector 4 and locking the position of the base member 6 of the wire member 3. This makes it possible to simplify the configuration of the assembly including the wire member 3.

(2) The accommodating portion 16 and the cover 17 are formed integrally. According to this configuration, component management is easier.

(3) Either the first engagement portions 30 or the second engagement portions 32 are projections 31 capable of elastic deformation. The other ones out of the first engagement portions 30 and the second engagement portions 32 are recesses 33 that transition the lock mechanism 29 to a locked state by engaging with the projections 31. The base member 6 has the holes 35 into which the projections 31 are inserted. The lock mechanism 29 locks the cover 17 to the accommodating portion 16, and also locks the position of the base member 6 relative to the accommodating portion 16, by engagement of the projections 31 inserted into the holes 35 in the base member 6 with the recesses 33. According to this configuration, the locking of the closed state of the cover 17 and the locking of the position of the base member 6 can be achieved with a single lock mechanism 29 using a simple configuration in which the projections 31 inserted into the holes 35 in the base member 6 are engaged with the recesses 33.

(4) The cover 17 includes the first wall portion 21 disposed facing a long side surface of the flat-shaped wire member 3 (the first surface 19), and the second wall portion 22 disposed facing a short side surface of the flat-shaped wire member 3 (the second surface 20) and in which the second engagement portion 32 is provided. The holes 35 are provided in the base member end 9 (the first base member end 10) formed in the end of the base member 6 in the direction in which the plurality of wires 2 are arranged next to each other. The lock mechanism 29 transitions to the locked state such that the base member end 9 (the first base member end 10) having the holes 35 with the projections 31 inserted therein is interposed between the accommodating portion 16 and the second wall portion 22. According to this configuration, when the position of the base member 6 of the wire member 3 is locked by the lock mechanism 29, the base member end 9 (the first base member end 10) is supported between the accommodating portion 16 and the second wall portion 22. This makes it possible to suppress movement of the base member 6 in the locked state. Accordingly, when the position of the base member 6 is locked by the lock mechanism 29, the locked state can be maintained with ease.

(5) The accommodating portion 16 has support portions 25 supporting the first wall portion 21 from a rear surface thereof when the cover 17 is in a closed state. According to this configuration, the first wall portion 21 of the cover 17 in the closed state is supported by the support portions 25 of the accommodating portion 16, and the cover 17 can therefore be stably kept in the closed state.

(6) The second wall portion 22 includes the first hinge 41 that connects the second wall portion 22 to the first wall portion 21 in a rotatable manner, and the second hinge 42 that enables the second wall portion 22 to bend, at an intermediate position between the tip of the second wall portion 22 and the first hinge 41. According to this configuration, the second wall portion 22 has a double-hinge structure, which increases the freedom of movement of the second wall portion 22. This makes it possible to improve the usability when closing the cover 17.

(7) The accommodating portion 16 includes extension portions 38 formed in a bottom wall 37 of the accommodating portion 16 and extending in a direction away from the bottom wall 37, and reinforcing portions 39 that reinforce the extension portions 38. The first engagement portions 30 are provided on corresponding ones of the extension portions 38 reinforced by the reinforcing portions 39. According to this configuration, the first engagement portions 30 are provided in a portion having high strength, which improves the durability of the lock mechanism 29. This makes it unlikely for the lock mechanism 29 to become unlocked unintentionally.

### Other Embodiments

Note that the present embodiment can be implemented with modifications such as those described hereinafter. The present embodiment and the following variations can be implemented in combination with each other to the extent that no technical conflicts arise.

The lock mechanism 29 may be a structure in which the recesses 33 are formed in the accommodating portion 16 and the projections 31 are formed in the cover 17. In other words, the first engagement portions 30 are not limited to being the projections 31, and may instead be the recesses 33, and the second engagement portions 32 are not limited to being the recesses 33, and may instead be the projections 31.

The recesses 33 are not limited to being through-holes, and may be grooves having a bottom.

The first engagement portions 30 are not limited to being disposed in the extension portions 38, and may be disposed at other locations of the accommodating portion 16.

The projections 31 are not limited to having shapes that project in a direction parallel to the bottom wall 37 of the accommodating portion 16, and may have shapes that project in a direction intersecting with the bottom wall 37, for example, depending on the arrangement position.

The components of the lock mechanism 29 (the first engagement portions 30, the second engagement portions 32, and the holes 35) are not limited to being provided on only one side surface of the protector 4, and may be formed on both side surfaces of the protector 4.

The base member 6 may be formed in a bag shape by wrapping a single sheet member into a circle, for example.

The base member end 9 may be formed on only one side of the base member 6 in the widthwise direction.

The shape of the holes 35 formed at the base member end 9 is not limited to a slit shape, and may be changed to another shape.

If the support portions 25 and the component attachment portion 26 are not present, the cutout 27 may be omitted from the base member 6.

The accommodating portion 16 and the cover 17 may be configured as separate members.

Only one set of a first engagement portion 30 and a second engagement portion 32 may be present.

The proximal end piece 43 and the distal end piece 44 may have shapes which are flush.

The second hinge 42 may be omitted from the second wall portion 22.

The electric wire assembly 1 and the protector 4 are not limited to being used in a vehicle, and may be used in other devices or apparatuses.

The expression "at least one" as used in the present disclosure means a desired "one or more" among options. For example, when two options are available, the expression "at least one" as used in the present disclosure means "only one of the options" or "both of the options". As another example, when three or more options are available, the expression "at least one" as used in the present disclosure means "only one of the options" or "any desired combination of two or more of the options".

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A protector comprising:
an accommodating portion configured to accommodate a wire member, in which a plurality of wires are bundled in a flat shape by a base member, in a state where the wire member is drawn out from both sides of the accommodating portion;
a cover configured to cover the accommodating portion to suppress rising of the wire member accommodated in the accommodating portion, and
a lock mechanism configured to lock the cover to the accommodating portion by engagement of a first engagement portion formed in the accommodating portion with a second engagement portion formed in the cover,
wherein the lock mechanism also locks a position of the base member relative to the accommodating portion.

2. The protector according to claim 1,
wherein the accommodating portion and the cover are formed integrally.

3. The protector according to claim 1,
wherein one of the first engagement portion and the second engagement portion is a projection capable of elastic deformation,
another one of the first engagement portion and the second engagement portion is a recess that engages with the projection to cause the lock mechanism to transition to a locked state,
the base member has a hole into which the projection is insertable, and
by the projection inserted into the hole in the base member engaging with the recess, the lock mechanism locks the cover to the accommodating portion and locks the position of the base member relative to the accommodating portion.

4. The protector according to claim 3,
wherein the cover includes
a first wall portion disposed facing a long side surface of the wire member having the flat shape, and
a second wall portion disposed facing a short side surface of the wire member having the flat shape, the second engagement portion being disposed in the second wall portion,
the hole is provided in a base member end formed at an end of the base member in a direction in which the plurality of wires are arranged next to each other, and
the lock mechanism transitions to the locked state such that the base member end having the hole with the projection inserted therein is interposed between the accommodating portion and the second wall portion.

5. The protector according to claim 4,
wherein the accommodating portion has a support portion supporting the first wall portion from a rear surface when the cover is in a closed state.

6. The protector according to claim 4,
wherein the second wall portion includes
a first hinge that connects the second wall portion to the first wall portion in a rotatable manner, and
a second hinge that enables the second wall portion to bend, at an intermediate position between a tip of the second wall portion and the first hinge.

7. The protector according to claim 1,
wherein the accommodating portion includes
an extension portion formed in a bottom wall of the accommodating portion and extending in a direction away from the bottom wall, and
a reinforcing portion that reinforces the extension portion, and
the first engagement portion is provided in the extension portion reinforced by the reinforcing portion.

8. A wire assembly comprising:
a wire member in which a plurality of wires are bundled in a flat shape by a base member; and
a protector configured to accommodate the wire member,
wherein the protector includes
an accommodating portion configured to accommodate the wire member in a state where the wire member is drawn out from both sides of the accommodating portion,
a cover configured cover the accommodating portion to suppress rising of the wire member accommodated in the accommodating portion, and
a lock mechanism configured lock the cover to the accommodating portion by engagement of a first engagement portion formed in the accommodating portion with a second engagement portion formed in the cover, and
the lock mechanism also locks a position of the base member relative to the accommodating portion.
